(19) United States
(12) Patent Application Publication
(10) Pub. No.: US 2024/0022894 A1
(43) Pub. Date: Jan. 18, 2024

(54) FIRST NETWORK NODE AND METHOD IN A COMMUNICATIONS NETWORK

(71) Applicant: Telefonaktiebolaget LM Ericsson (publ), Stockholm (SE)

(72) Inventors: Francesco TORO, Baronissi (SA) (IT); Laura COPPA, Nocera Inferiore (IT); Laura PAPPACENA, Sarno (IT)

(21) Appl. No.: 18/255,482

(22) PCT Filed: Dec. 9, 2020
(86) PCT No.: PCT/SE2020/051186

§ 371 Date: Jun. 1, 2023

(51) Int. Cl. H04W 8/06; H04W 8/08

(52) U.S. Cl. CPC H04W 8/06; H04W 8/08

(57) ABSTRACT

A method performed by a first network node in a Visited Public Land Mobile Network, VPLMN. The first network node is related to Lawful Intercept, LI, in the VPLMN. The first UE is associated with a Home Public Land Mobile Network, HPLMN and is located in the VPLMN. When the communication is started, the first network node receives a first Session Initiation Protocol, SIP, message from a gateway node in the VPLMN. The first SIP message includes first data related to starting of the communication. The first network node determines, based on analysing the first data, first communication data. The first network node sends a first request to a second network node operating in the VPLMN. The first request includes the determined first communication data and requests a first action to be performed by the second network node.

### TECHNICAL FIELD

Embodiments herein relate to a first network node and a method therein. In some aspects, they relate to determining data related to a communication between a first User Equipment (UE) and a second UE in a communications network.

### BACKGROUND

In a typical wireless communication network, wireless devices, also known as wireless communication devices, mobile stations, stations (STA) and/or User Equipments (UE), communicate via a Local Area Network such as a Wi-Fi network or a Radio Access Network (RAN) to one or more core networks (CN). The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

Specifications for the Evolved Packet System (EPS), also called a Fourth Generation (4G) network, have been completed within the 3rd Generation Partnership Project (3GPP) and this work continues in the coming 3GPP releases, for example to specify a 5G network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs used in 3G networks. In general, in E-UTRAN/LTE the functions of a 3G RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

Multi-antenna techniques may significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO.

An S8 Home Routing (S8HR) architecture has been selected by the Global System for Mobile Communications Association (GSMA) and 3GPP as reference architecture for Internet Protocol (IP) Multimedia Subsystem (IMS) Roaming.

With S8HR IMS Roaming, an IMS Access Point Name (APN) is resolved to a Packet Data Network (PDN) Gateway (PGW) in a Home Public Land Mobile Network (HPLMN) as shown in FIG. 1. In addition, Quality of Service (QoS) level roaming support is required to support IMS Voice and Video telephony (VoIMS), i.e. service specific QoS other than the default QoS are supported on a home routed PDN connection for the IMS APN when roaming. In FIG. 1, MME means Mobility Management Entity, SGW means Serving Gateway, HSS means Home Subscriber Server, PCRF means Policy and Charging Rules Function, P-CSCF means Proxy Call Session Control Function, S-CSCF means Serving CSCF, TAS means Telephony Application Server, IBCF/BGCF/MGCF means Interconnect Boarder Control Function/Breakout Gateway Control Function/Media Gateway Control Function, IMS AGW/TrGW means IMS Access Gateway/Transition Gateway and IPX means Internetwork Packet Exchange.

The HPLMN and Visited Public Land Mobile Network (VPLMN) requires exchanging information and given a roaming agreement, enable IMS roaming via S8HR considering local regulatory requirements in the VPLMN. The HPLMN requires to ensure, based on the roaming agreement, that IMS layer signaling and media confidentiality protection is not activated in order to enable the VPLMN to meet the local regulatory requirements.

If the HPLMN uses IMS layer signaling and media confidentiality protection on its network, e.g. for the HPLMN's own subscribers and for inbound roaming Local Breakout (LBO) IMS subscribers, then, based on the customer location retrieved through subscription to the Policy and Charging Rules Function (PCRF), this protection shall be deactivated in the HPLMN, to support S8HR outbound roamers.

Regulatory requirements in a country of the VPLMN require an operator to support Lawful Intercept (LI) and Data Retention. Those functions require the VPLMN to handle Voice over LTE (VoLTE) calls at the application layer in order to handle the communications identities and signaling.

As there is no IMS node in the VPLMN, interception of VoLTE inbound roaming subscribers' traffic is only possible in the nodes of the EPS domain. This implies that there is no possibility to retrieve information about Session Initiation Protocol (SIP) identities, IMS signaling and payload. This poses severe limitations to the effectiveness of the interception of VoLTE calls for inbounding roamers.

To overcome this limitation, 3GPP has specified the Lawful Interception architecture and the Data Retention Architecture for the S8HR architecture. By introducing two new functional entities, LI Mirror IMS State Function (LMISF) and Bearer Binding Intercept and Forwarding Function (BBIFF), it is possible to intercept the VoLTE calls to and/or from inbound roamers in EPC nodes, which provides IMS-like interception.

LMISF

The LMISF mirrors a home network's Session Boarder Gateway (SBG) functionality. It keeps a list of the IMS targets, generates “IMS-like” Intercept Related Information (IRI), triggers the Content of Communications (CC) interception for those VoLTE inbound roamers' communications related to the intercepted targets and sends them to the LI Mediation Function.

BBIFF

The BBIFF is a functionality in the Serving Gateway (S-GW) in the EPC network. It recognizes the IMS signaling packets related to the VoLTE inbound roamers' communications, captures the IMS media packets related to the intercepted targets and forwards them to the LMISF.

With the S8HR Roaming Architecture, the VPLMN is only QoS and APN aware. This may lead to not being able comply with service requirements and disrupted services for roaming UEs.

### SUMMARY

As a part of developing embodiments herein a problem was identified by the inventors and will first be discussed.

As currently defined, the VPLMN is QoS and APN aware when the S8HR is used for roaming. This allows measuring and other following up of a communication, such as e.g. charging a communication, to be based on either APN or QoS Class Identifier (QCI). In the former case, voice and SIP signaling will not be differentiated. In the latter case, voice and SIP signaling charging is differentiated by different QCI. QCI=1 for voice and QCI=5 for SIP signaling. In both cases, the charging is based on the data volume used.

The VPLMN has no way to be service aware for roaming UEs, and thus cannot provide time-based feedback of a communication, such as offline charging according to offline charging requirements. This because the VPLMN is not able to handle at the application layer for VoLTE calls and the related communications identities and signaling. Instead the VPLMN can only to handle the raw data volume. This may lead to inability to adhere to service requirements and may result in disrupted services for roaming UEs.

An object of embodiments herein is to improve the performance of a communications network using S8HR architecture for roaming UEs.

According to an aspect of embodiments herein, the object is achieved by a method performed by a first network node in a Visited Public Land Mobile Network, VPLMN, for determining data related to a communication between a first User Equipment, UE, and a second UE in a communications network. The first network node is related to Lawful Intercept, LI, in the VPLMN. The first UE is associated with a Home Public Land Mobile Network, HPLMN. The first UE is located in the VPLMN. When the communication is started, the first network node receives a first Session Initiation Protocol, SIP, message from a gateway node in the VPLMN. The gateway node is related to LI in the VPLMN. The first SIP message comprises first data related to starting of the communication. The first network node determines, based on analyzing the first data, a first communication data. The first communication data comprises: Identities of the first UE and the second UE, a time related to the communication, type of content in the communication, and roaming user location information related to the first UE of the communication. The first network node sends a first request to a second network node operating in the VPLMN. The first request comprises the determined first communication data and requests a first action to be performed by the second network node. The first action is related to the communication based on the determined first communication data.

According to another aspect of embodiments herein, the object is achieved by a first network node in an Visited Public Land Mobile Network, VPLMN, configured to determine data related to a communication between a first User Equipment, UE, and a second UE in a communications network, wherein the first network node is related to Lawful Interception, LI, in the VPLMN, which first UE is associated with an Home Public Land Mobile Network, HPLMN, and which first UE is located in the VPLMN. The first network node further is configured to:
When the communication is started, receive a first Session Initiation Protocol, SIP, message from a gateway node in the VPLMN, wherein the gateway node is related to LI in the VPLMN, and wherein the first SIP message is adapted to comprise first data related to starting the communication,
determine, based on analysing the first data, first communication data adapted to comprise:
identities of the first UE and the second UE,
a time related to the communication,
type of content in the communication, and
roaming user location information related to the first UE of the communication,
send a first request to a second network node operating in the VPLMN, which first request is adapted to comprise the determined first communication data and is further adapted to request a first action to be performed by the second network node, which first action is adapted to be related to the communication based on the determined first communication data.

Thanks to that the first network node receives a first SIP message related to a communication between the first UE and the second UE comprising first data, and that the first network node determines, based on the first data, first communication data, it is possible for the first network node to request a first action to be performed by the second network node, where the first action is related to the communication and based on the first communication data. In this way an efficient mechanism improving service handling when using S8HR architecture is achieved.

Embodiments herein brings the advantage of an efficient mechanism improving service handling when using S8HR architecture for roaming UEs. This is achieved by making it possible for the VPLMN to determine communication data related to a communication, which leads to a more efficient method for handling services in the VPLMN for roaming UEs when using the S8HR architecture.

### BRIEF DESCRIPTION OF THE DRAWINGS

Examples of embodiments herein are described in more detail with reference to attached drawings in which:

FIG. 1 is a schematic block diagram illustrating prior art.

FIG. 2a is a schematic block diagram illustrating embodiments of a communications network.

FIG. 2b is a schematic block diagram illustrating an example embodiment.

FIG. 3 is a flowchart depicting embodiments of a method in a first network node.

FIG. 4 is a schematic block diagram illustrating embodiments of a roaming architecture in a communications network.

FIG. 5 is a sequence diagram depicting embodiments of a method.

FIG. 6 is a sequence diagram depicting embodiments of a method.

FIG. 7a-b are schematic block diagrams illustrating embodiments of a first network node.

FIG. 8 schematically illustrates a telecommunication network connected via an intermediate network to a host computer.

FIG. 9 is a generalized block diagram of a host computer communicating via a base station with a user equipment over a partially wireless connection.

FIGS. 10-13 are flowcharts illustrating methods implemented in a communication system including a host computer, a base station and a user equipment.

### DETAILED DESCRIPTION

Embodiments herein relates to a communications network and for determining data related to a communication between a first UE in an VPLMN and a second UE.

Example embodiments herein provides methods that improves the determination of data related to a communication between the first UE in the VPLMN and the second UE, by allowing a first network node in the VPLMN to receive and analyze SIP messages comprising data. This allows the first network node to request actions to be performed based on determined communication data.

Further, some embodiments herein provide methods that improves the determination of data related to the communication between the first UE in the VPLMN and the second UE, by allowing the first network node to determine data related to time-based offline charging for VoLTE inbound roaming, thereby enabling the first network node to request actions related to time-based offline charging in for roaming UEs when the S8HR architecture is used. This results in a more efficient method for handling services in the VPLMN for roaming UEs when using the S8HR architecture.

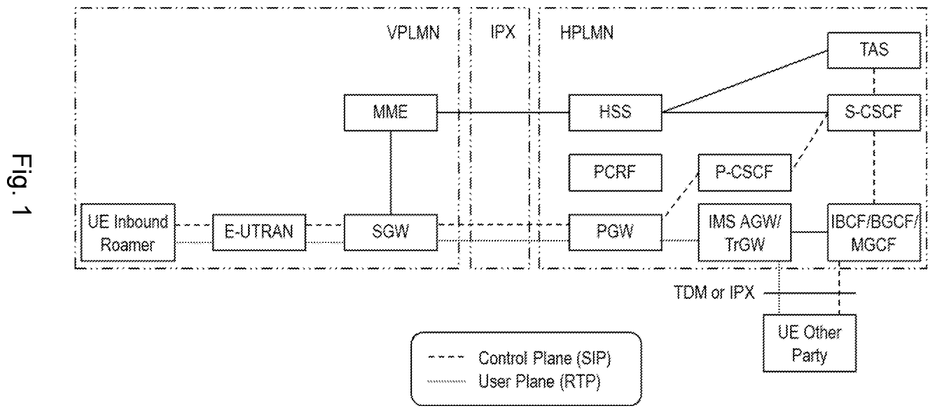

FIG. 1b is a schematic overview depicting a communications network 100 wherein embodiments herein may be implemented. The communications network 100 comprises one or more RANs and one or more CNs. The communications network 100 may use a number of different technologies, such as Wi-Fi, Long Term Evolution (LTE), LTE-Advanced, 5G, New Radio (NR), Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

A number of network nodes operate in the communications network 100 such as e.g. a network node 105. The network node 105 provides radio coverage in a number of cells which may also be referred to as a beam or a beam group of beams, such as a cell provided by the network node 105.

The network node 105 may be any of a NG-RAN node, a transmission and reception point e.g. a base station, a radio access network node such as a Wireless Local Area Network (WLAN) access point or an Access Point Station (AP STA), an access controller, a base station, e.g. a radio base station such as a NodeB, an evolved Node B (eNB, eNode B), a gNB, a base transceiver station, a radio remote unit, an Access Point Base Station, a base station router, a transmission arrangement of a radio base station, a stand-alone access point or any other network unit capable of communicating with a wireless device within the service area served by the network node 105 depending e.g. on the first radio access technology and terminology used. The network node 105 may be referred to as a serving network node and communicates with a first UE 121 and a second UE 122 with Downlink (DL) transmissions to the first UE 121 and the second UE 122 and Uplink (UL) transmissions from the first UE 121 and the second UE 122.

One or more UEs operate in the communication network 100, such as e.g. the first UE 121 and the second UE 122. The first UE 121 and the second UE 122 may also referred to as devices, IoT devices, mobile stations, non-access points (non-AP) STAs, STAs, user equipments and/or a wireless terminals, communicating via one or more Access Networks (AN), e.g. the RAN, to one or more CNs. It should be understood by the skilled in the art that “wireless device” is a non-limiting term which means any terminal, wireless communication terminal, user equipment, Machine Type Communication (MTC) device, Device to Device (D2D) terminal, a radio device in a vehicle, or node e.g. smart phone, laptop, mobile phone, sensor, relay, mobile tablets or even a small base station communicating within a cell.

Nodes in the communications network 100 may further communicate with nodes in another network 102, e.g. a Home Public Land Mobile Network (HPLMN) for the first UE 121.

Further, network nodes such as a first network node 131, a second network node 132 and a gateway node 140 operate in the communication network 100. The first network node 131 and the second network node 132 may respectively be referred to as a LMISF node and a BBIFF node. The gateway node 140 may also be referred to as a Charging Data Function (CDF).

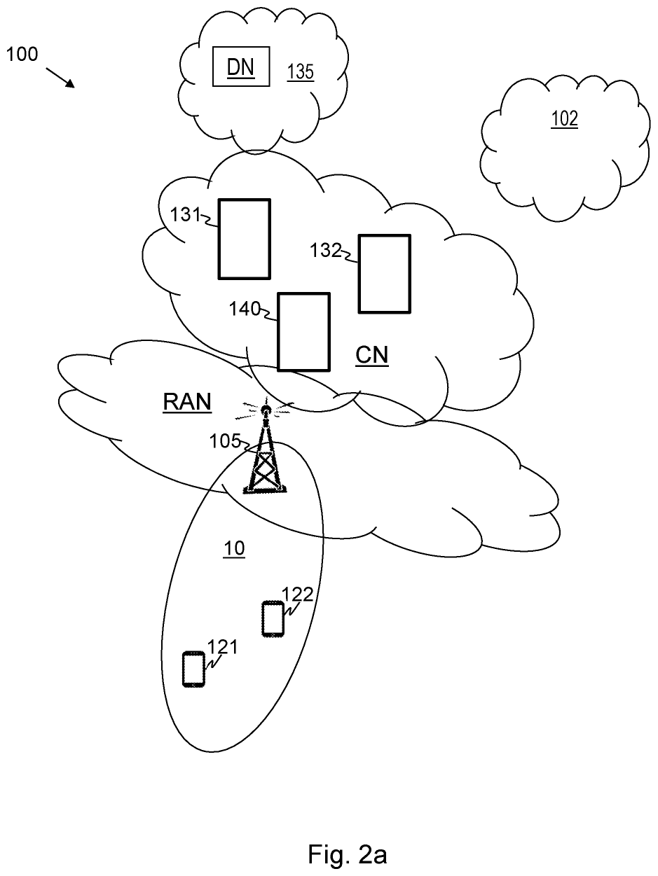

Methods herein may be performed by the first network node 131. As an alternative, a Distributed Node (DN) and functionality, e.g. comprised in a cloud 135 as shown in FIG. 2a, may be used for performing or partly performing the methods herein.

FIG. 2b shows a part of the communications network 100 according to an example scenario wherein embodiments herein may be applied. The first network node 131 may communicate with the gateway node 140 and the second network node 132. The first network node may receive SIP messages from the gateway node 140. The SIP message may trigger the first network node 131 to act as a Charging Trigger Function (CTF). The first network node 131 may send message to and receive messages from the second network node 132. The first network node sends a request to the second network node 132, requesting an action to be performed.

A number of embodiments will now be described, some of which may be seen as alternatives, while some may be used in combination.

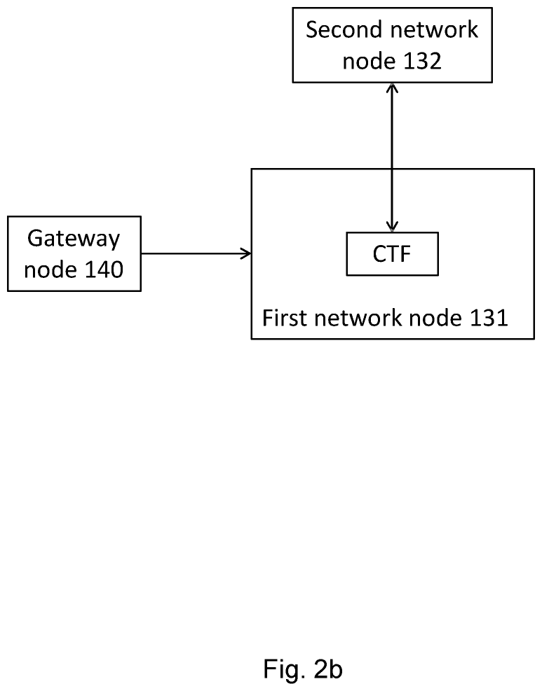

FIG. 3 shows example embodiments of a method performed by a first network node 131 in an VPLMN for determining data related to a communication between a first UE 121 and a second UE 122 in a communications network 100.

The first network node 131 is related to LI in the VPLMN. The first UE 121 is associated with an HPLMN and is located in the VPLMN.

The communication may be routed via the S8 interface according to the S8HR architecture. In some embodiments, any one or more out of the first network 131 node is a LMISF node, and the gateway node 140 is a BBIFF node.

The method comprises any one or more out of the actions below, which actions may be taken in any suitable order. Actions that are optional are presented in dashed boxes in FIG. 3.

Action 301

To handle the communication between a first UE, such as the first UE 121 located in a VPLMN, and a second UE, such as the second UE 122, SIP signaling is used to start the communication.

When the communication is started, the first network node 131 receives a first SIP message from the gateway node 140 in the VPLMN. The gateway node 140 is related to LI in the VPLMN. The first SIP message comprises first data related to starting of the communication. The words first, second and third together with the wording SIP message when used herein, may but need not be related to the order of the messages but are just used to differentiate a SIP message from any other SIP message received by the first network node 131, such as e.g. a first SIP message, one or more second SIP messages or a third SIP message described below. The communication may e.g. be a VoLTE communication session.

In some embodiments, the first SIP message further comprises triggering the first network node 131 to act as a CTF. This may mean that the first SIP message triggers the first network node 131 to act as a CTF. This is an advantage since it allows the first network node 131 to determine communication data related to charging.

Action 302

As mentioned above, the first SIP message comprises first data related to the starting of the communication. Based on the first data, first communication data may be determined. The first data may be data comprised in e.g. the headers or the body of the first SIP message.

The first network node determines a first communication data based on analyzing the first data. The first communication data comprises identities of the first UE 121 and the second UE 122, a time related to the communication, a type of content in the communication, and roaming user location information related to the first UE 121 of the communication.

The first communication data may further comprise a charging identifier determined by the first network node 131. The charging identifier may be determined to be unique to the VPLMN. The charging identifier may be an IMS charging identifier. This charging identifier is different from a charging identifier determined in the HPLMN.

The determined first communication data makes it possible for the first network node 131 to decide to send a first request to the second network node 132 in next action.

Action 303

The first network node 131 sends the first request to the second network node 132 operating in the VPLMN. The first request comprises the determined first communication data and requests a first action to be performed by the second network node 132. The first action is related to the communication based on the determined first communication data. The first action may further be based on a SIP method represented by the first SIP message.

As mentioned above, the first network node 131 may in some embodiments be triggered to act as a CTF. Therefore, in some of these embodiments, the request sent to the second network node 132 is a charging request

The requested action may further be related to time-based charging. The second network node 132 may be a CDF. This allows the first network node 131 to provide time-based offline charging relating to a UE, such as the UE 121, located in the VPLMN.

The requested action may be represented by either a session related or a session unrelated action. The wording session related and session unrelated when used herein, is used to differentiate between actions related to a successful SIP session, such as e.g. a call session, and actions unrelated to SIP session or an unsuccessful SIP session, such as e.g. SIP SUBSCRIBE event or an unsuccessful SIP session setup.

In some embodiments, the requested action is represented by a session related action comprising any one out of: An Accounting Request (ACR) Start action, an ACR Interim action, or an ACR Stop action.

In some embodiments, the requested action is represented by a session unrelated action comprising an ACR Event action.

As mentioned above, the first communication data comprises a time related to the communication in some embodiments. In some of these embodiments, the requested action is a session related action. In some of these embodiments, the time related to the communication comprises any one or more out of: A start time of the communication, an end time of the communication, a time duration of the communication, and a time of the request. When the requested action is a session related action, the time of the communication may depend whether the requested action comprises an ACR Start action, an ACR Interim Action or an ACR Stop action. A time duration of the communication may be any one or more out of e.g. a total time duration of the communication and a time duration related to a part of the communication.

In some embodiments, the requested action is a session unrelated action, and wherein the time related to the communication comprises a time of the sent first request.

In response the sent request, the first network node 131 may receive an acknowledgement message from the second network node. The acknowledgement message may be an Accounting Answer (ACA) message.

Action 304

During the communication between the first UE 121 and the second UE 122, SIP signaling may occur, e.g. related to changes in the communication.

In some embodiments, the first network node 131 receives one or more second SIP messages from the gateway node 140 during the communication. The one or more second SIP messages comprises second data related to updating the communication. An updating the communication may e.g. be, but is not limited to, changes in media components, mid-dialog requests and terminating identity changes.

Action 305

As mentioned above, the one or more second SIP message comprises second data related to updating of the communication. Based on the second data, second communication data may be determined. The second data may be data comprised in e.g. the headers or the body of the second SIP message.

So, in some embodiments, the first network node 131 determines second communication data based on analyzing any one out of: The second data, or the first data and the second data. This means that the first network node 131 determines the second communication data based on an analysis of the second data, or the first data and the second data.

The second communication data may be determined based on analyzing the first data and an expiration of a timer.

As for the first communication data, the second communication data may comprise identities of the first UE 121 and the second UE 122, a time related to the communication, type of content in the communication, and roaming user location information related to the first UE 121 of the communication. The second communication data may further comprise an identity of a third UE 123. The third UE 123 may be related to the second UE 122.

The determined second communication data allows the first network node 131 to decide a second request to send to the second network node 132.

Action 306

In some embodiments, the first network node 131 sends a second request to the second network node 132. The second request comprises the determined second communication data and requests a second action to be performed by the second network node 132. The second action is related to the communication based on the determined second communication data. The second action may further be based on a SIP method represented by the one or more second SIP messages.

As mentioned above, the first network node may be triggered to act as a CTF. Therefore, in some embodiments, the request sent to the second network node 132 is a charging request. The requested action is further related to time-based charging, and the second network node 132 is a CDF. As mentioned above, this allows the first network node 131 to provide time-based offline charging to a UE, such as the UE 121, located in the VPLMN.

As mentioned above, the requested action may be represented by either a session related or a session unrelated action.

In some embodiments, the requested action is represented by a session related action comprising any one out of: An ACR Start, action, an ACR Interim action, or an ACR Stop action.

The requested action may be represented by a session unrelated action comprising an ACR Event action.

As mentioned above, the first communication data comprises a time related to the communication.

In some embodiments, the requested action is a session related action, and wherein the time related to the communication comprises any one or more out of: A start time of the communication, an end time of the communication, a time duration of the communication, and a time of the request. When the requested action is a session related action, the time of the communication may depend on whether the requested action comprises an ACR Start action, an ACR Interim Action or an ACR Stop action. A time duration of the communication may be any one or more out of e.g. a total time duration of the communication and a time duration related to a part of the communication.

In some embodiments, the requested action is a session unrelated action, and wherein the time related to the communication comprises a time of the sent first request.

In response the sent request, the first network node 131 may receive an acknowledgement message from the second network node. The acknowledgement message may be an ACA message.

Action 307

At the end of the communication between the first UE 121 and the second UE 122, SIP signaling may occur.

Therefore, in some embodiments, at the end of the communication, the first network node 131 receives one or more third SIP messages from the gateway node 140. The one or more third SIP messages comprises third data related to ending the communication.

Action 308

The one or more third SIP message comprises, as mentioned above, third data related to ending the communication. Based on the third data, third communication data may be determined. The third data may be data comprised in e.g. the headers or the body of the third SIP message.

In some embodiments, the first network node 131 determines a third communication data based on analyzing any one out of: the third data, the first data and the third data, the second data and the third data, or the first data, the second data and the third data. As for the first communication data, the third communication data may comprise identities of the first UE 121 and the second UE 122, a time related to the communication, type of content in the communication, and roaming user location information related to the first UE 121 of the communication. The third communication data may further comprise the identity of the third UE 123.

The determined third communication data allows the first network node 131 to decide a third request to send to the second network node 132.

Action 309

In some embodiments, the first network node 131 sends a third request to the second network node 132. The third request comprises the determined third communication data and requests a third action to be performed by the second network node 132. The third action is related to the communication based on the determined third communication data. The third action may further be based on a SIP method represented by the one or more third SIP messages.

As mentioned above, the first network node may be triggered to act as a CTF.

Therefore, in some embodiments, the request sent to the second network node 132 is a charging request. The requested action is further related to time-based charging, and the second network node 132 is a CDF. As mentioned above, this allows the first network node 131 to provide time-based offline charging to a UE, such as the UE 121, located in the VPLMN.

As mentioned above, the requested action may be represented by either a session related or a session unrelated action.

In some embodiments, the requested action is represented by a session related action comprising any one out of: An ACR Start, action, an ACR Interim action, or an ACR Stop action.

The requested action may be represented by a session unrelated action comprising an ACR Event action.

As mentioned above, the first communication data comprises a time related to the communication.

In some embodiments, the requested action is a session related action, and wherein the time related to the communication comprises any one or more out of: A start time of the communication, an end time of the communication, a time duration of the communication, and a time of the request. When the requested action is a session related action, the time of the communication may depend on whether the requested action comprises an ACR Start action, an ACR Interim Action or an ACR Stop action. A time duration of the communication may be any one or more out of e.g. a total time duration of the communication and a time duration related to a part of the communication.

In some embodiments, the requested action is a session unrelated action, and wherein the time related to the communication comprises a time of the sent first request.

In response the sent request, the first network node 131 may receive an acknowledgement message from the second network node. The acknowledgement message may be an ACA message.

Embodiments herein such as mentioned above will now be further described and exemplified. The text below is applicable to and may be combined with any suitable embodiment described above.

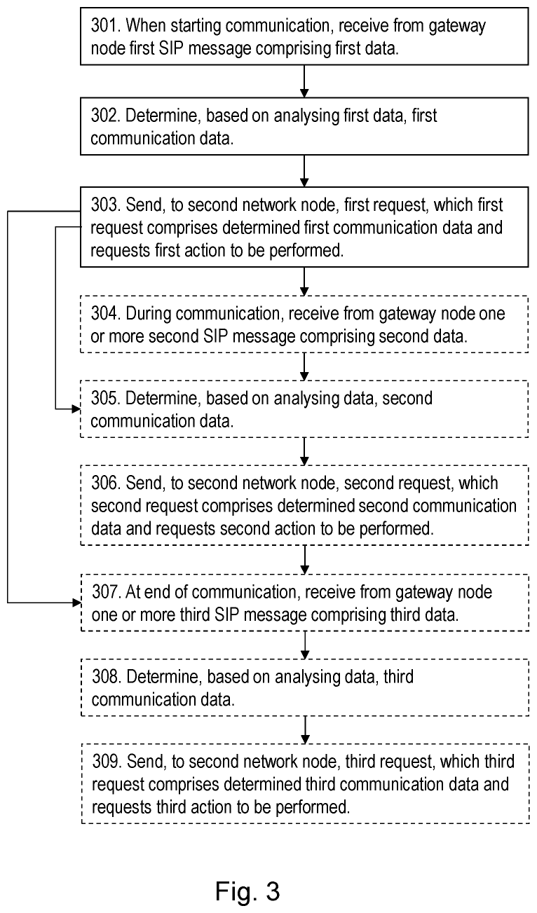

FIGS. 4a and b illustrates an example embodiment of a roaming architecture implementing the S8HR architecture according to embodiments herein.

When S8HR is used as the roaming architecture for VoLTE, all of the IMS nodes reside in the HPLMN. Consequently, the IMS signaling messages are exchanged between the UE and the P-CSCF in HPLMN via a Serving Gateway in the VPLMN that will handle the S8 interface towards the HPLMN.

The LMISF, such as the first network node 131, instructs, over the Xib interface, the BBIFF, such as the gateway node 140, to mirror the IMS signaling, such as SIP messages, generated and directed to all VoLTE roamers. These messages will be provided by BBIFF, such as the gateway node 140, to LMISF, such as the first network node 131, over the Xia interface.

The LMISF, such as the first network node 131, analyses the received SIP messages. Based on the analysis, the LMISF, such as the first network node 131, generates CDRs, such as according the table below. The CDRs, such requests comprising communication data, are provided to the CDF, such as the second network node 132, over the Rf interface.

The below table shows the CDR, such requests comprising communication data, types generated by LMISF, such as the first network node 131, based on the triggering SIP messages provided by BBIFF, such as the gateway node 140.

| Message | Triggering SIP method |
|---|---|
| Charging | SIP 2xx acknowledging an initial SIP INVITE |
| Data | SIP ACK acknowledging an initial SIP INVITE |
| Request | |
| [ACR | |
| Start] | |
| Charging | SIP 2xx acknowledging a SIP RE-INVITE or SIP |
| Data | UPDATE [e.g. change in media components, terminating |
| Request | identity change] |
| [ACR | SIP ACK acknowledging an initial SIP INVITE or a SIP |
| Interim] | RE-INVITE |
| | Expiration of Interim Interval |
| | SIP 1xx provisional response, mid-dialog requests, mid-dialog |
| | responses and SIP INFO embedding RTTI XML body |
| | (applicable for the S-CSCF and IBCF). |
| | SIP response (4xx, 5xx or 6xx), indicating an unsuccessful |
| | SIP RE-INVITE or SIP UPDATE |
| Charging | SIP BYE message (both normal and abnormal session |
| Data | termination cases) |
| Request | SIP 2xx acknowledging a SIP BYE message (only when last |
| [ACR | user location information of originating/terminating party is |
| Stop] | required by operator for legal purpose) |
| Charging | SIP 2xx acknowledging non-session related SIP messages, |
| Data | which are: |
| Request | SIP NOTIFY |
| [ACR | SIP MESSAGE |
| Event] | SIP REGISTER |
| | SIP SUBSCRIBE |
| | SIP PUBLISH |
| | SIP REFER |
| | SIP 2xx acknowledging an initial SIP INVITE (BGCF and |
| | I-CSCF only) |
| | SIP Final/Redirection Response 3xx |
| | SIP Final Response (4xx, 5xx or 6xx), indicating an |
| | unsuccessful SIP session set-up |
| | SIP Final Response (4xx, 5xx or 6xx), indicating an |
| | unsuccessful session-unrelated procedure |
| | SIP CANCEL, indicating abortion of a SIP session set-up |

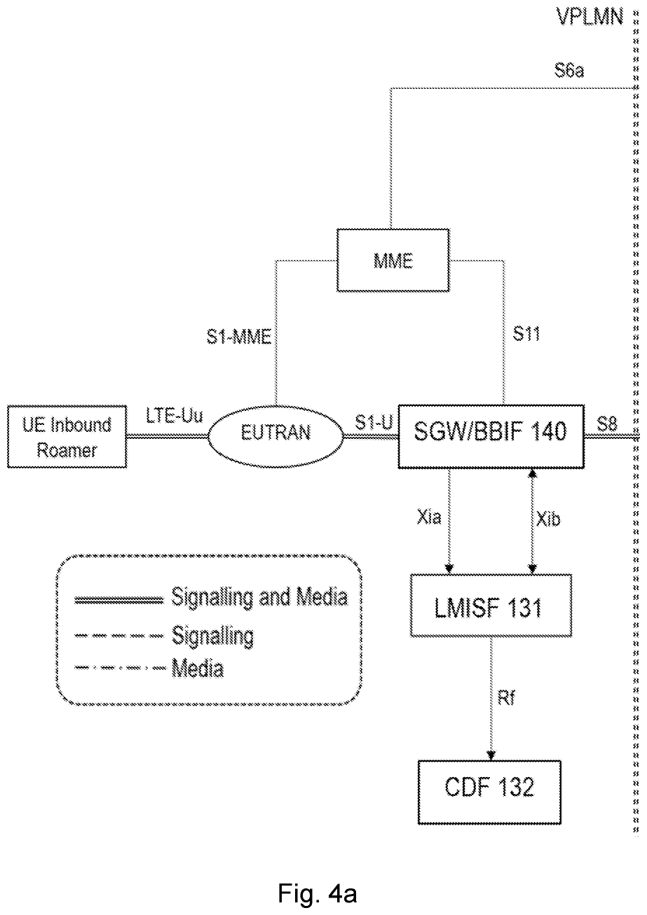

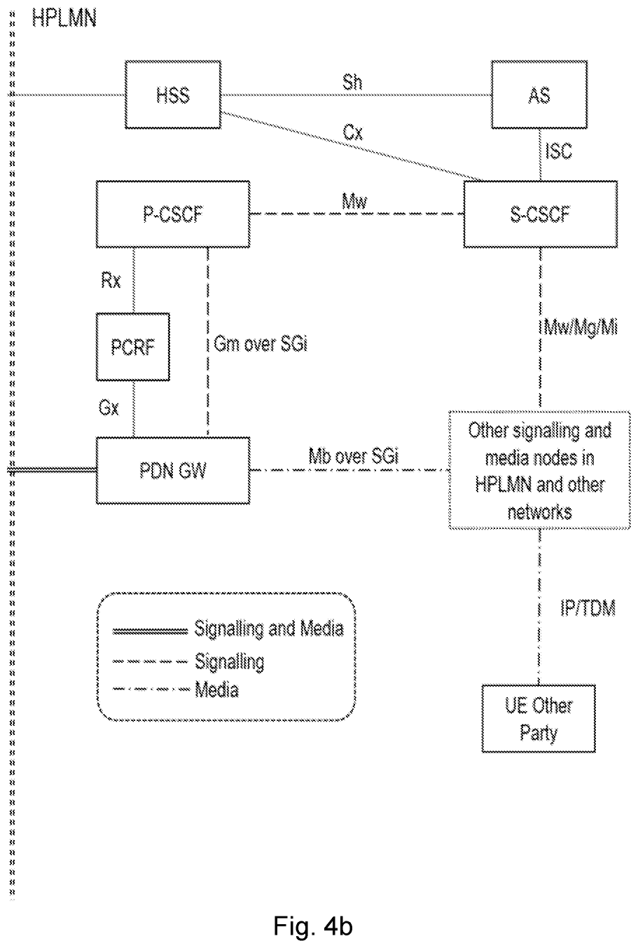

FIGS. 5 and 6 show example steps for an implementation example according to embodiments herein. In FIGS. 5 and 6 the first network node 131 is referred to as LMISF 131, the gateway node 140 is referred to as BBIFF 140, the second network node 132 is referred to as CDF 132 and the first UE 121 is referred to as UE 121.

FIG. 5 shows steps, such as actions, according to an example embodiment, for session related charging requests. In case of SIP signaling related to a call session, the following charging request may be generated by the LMISF 131. The requests will be sent towards the CDF 132.

In session related requests the following main information may be provided:
Participants identities.
A time related to the session, such as the communication, such as e.g. start time, end time, duration or time of the request.
Type of used content, such as e.g. audio, video or text.
Roaming user location information.

Action 501

The LIMSF 131 receives a call session setup message, e.g. a SIP INVITE message, from the BBIFF 140. The SIP INVITE message is related to the communication between the UE 121 and a second UE, such as the second UE 122, (not shown). The LMISF 131 subsequently receives a SIP 180 message, a SIP 2000K message and a SIP ACK message from the BBIFF 140, all related to the communication between the UE 121 and a second UE, such as the second UE 122, (not shown). When the call setup complete message such as the first SIP message comprising first data, e.g. the SIP 200 OK or SIP ACK, is received, the LMISF 131 sends an ACR Start, such as the first request comprising first communication data, to the CDF 132.

Action 502

The LIMSF 131 receives a call session modification, such as e.g. call put on-hold, via e.g. a SIP UPDATE message from the BBIFF 140. The SIP UPDATE message is related to the communication between the UE 121 and the second UE, such as the second UE 122, (not shown). The LMISF 131 subsequently receives a SIP 2000K message from the BBIFF 140, related to the communication between the UE 121 and a second UE, such as the second UE 122, (not shown). When the acknowledgement, such as the one or more second SIP messages comprising second data, e.g. the SIP 200 OK message, for the call session modification is received, the LMISF 131 sends an ACR Interim, such as the second request comprising second communication data, to the CDF 132.

Action 503

The LIMSF 131 receives a call session tear down message, e.g. a SIP BYE message, from the BBIFF 140. The SIP BYE message is related to the communication between the UE 121 and the second UE, such as the second UE 122, (not shown). The LMISF 131 subsequently receives a SIP 2000K message from the BBIFF 140 related to the communication between the UE 121 and a second UE, such as the second UE 122, (not shown). When acknowledgement, such as the one or more third SIP messages comprising third data, e.g. the SIP 200 OK message, for the call session teardown is received, the LMISF 131 sends an ACR Stop, such as the third request comprising third communication data, to the CDF 132.

FIG. 6 shows steps, such as actions, according to another example embodiment, for session unrelated charging requests. In case of SIP signaling not related to a call session, the following charging request will be generated by the LMISF 131. The requests will be sent towards the CDF 132. Step 601 and Step 602 depicted in FIG. 6 are not necessarily related to each other, but merely shows two different examples of session unrelated charging requests.

In session related requests the following main information are provided:
Participants identities.
A time related to the session, such as the communication, such as e.g. time of the request.
Type of used content, such as e.g. image, xml or text.
Roaming user location information.

Action 601

The LIMSF 131 receives a registration message, e.g. a SIP REGISTER message, from the BBIFF 140. The LMISF 131 subsequently receives a SIP 2000K message from the BBIFF 140. When the registration acknowledgement message, such as any one out of the first, one or more second or one or more third SIP messages comprising respective first, second or third data, e.g. the SIP 200 OK, is received, the LMISF 131 sends an ACR Event, such as any one out of the first, second or third requests comprising respective first, second or third communication data, to the CDF 132.

Action 602

The LIMSF 131 receives an instant messaging (IM) message, e.g. a SIP MESSAGE message, from the BBIFF 140. The LMISF 131 subsequently receives a SIP 2000K message from the BBIFF 140. When the IM acknowledgement message, such as any one out of the first, one or more second or one or more third SIP messages comprising respective first, second or third data, e.g. the SIP 200 OK, is received, the LMISF 131 sends an ACR Event, such as any one out of the first, second or third requests comprising respective first, second or third communication data, to the CDF 132.

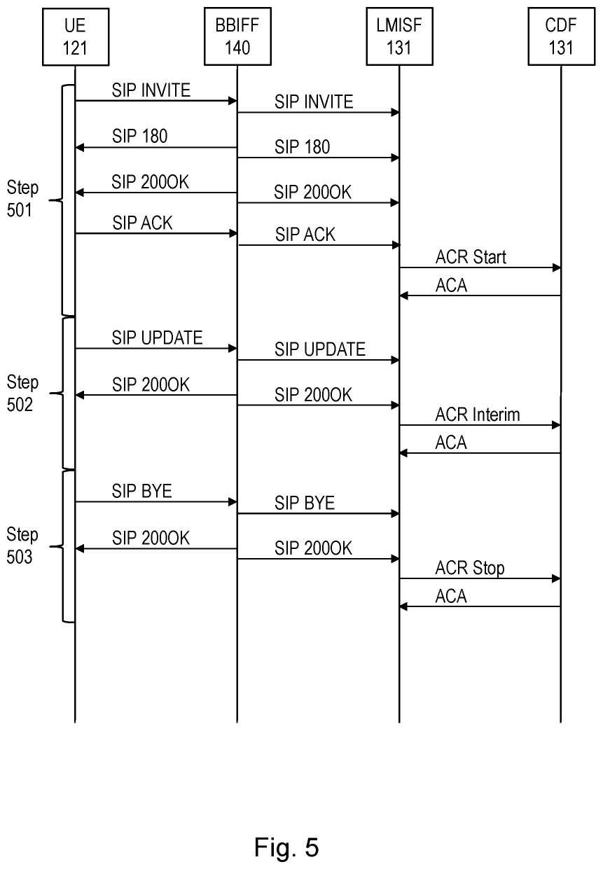

To perform the method actions above, the first network node may comprise an arrangement depicted in FIGS. 7a and b. The first network node 131 in an VPLMN is configured to determine data related to a communication between a first UE 121 and a second UE 122 in a communications network 100. The first network node 131 is related to Lawful Interception, LI, in the VPLMN. The first UE 121 is associated with an HPLMN. The first UE 121 is located in the VPLMN.

The communication may be adapted to be routed via the S8 interface according to the S8HR architecture.

Any one or more out of: The first network 131 node may be a LMISF node, and the gateway node 140 may be a BBIFF node.

The first network node 131 may comprise an input and output interface 700 configured to communicate with network nodes such as the gateway node 140 and the second network node 132. The input and output interface may comprise a wireless receiver (not shown) and a wireless transmitter (not shown).

The first network node 131 is further configured to, e.g. means of a receiving unit 710, when the communication is started, receive a first SIP message from the gateway node 140 in the VPLMN. The gateway node 140 is related to LI in the VPLMN. The first SIP message is adapted to comprise first data related to starting the communication.

The first SIP message may be adapted to trigger the first network node 131 to act as a CTF.

The first network node 131 may further by configured to, e.g. means of the receiving unit 710, during the communication, receive one or more second SIP messages from the gateway node 140. The one or more second SIP messages may be adapted to comprise second data related to updating the communication.

The first network node 131 may further by configured to, e.g. means of the receiving unit 710, at the end of the communication, receive one or more third SIP messages from the gateway node 140. The one or more third SIP messages may be adapted to comprise third data related to ending the communication.

The first network node 131 is further configured to, e.g. means of a determining unit 720, determine, based on analyzing the first data, first communication data adapted to comprise: Identities of the first UE 121 and the second UE 122, a time related to the communication, type of content in the communication, and roaming user location information related to the first UE 121 of the communication.

The first network node 131 may further be configured to, e.g. means of the determining unit 720, determine second communication data based on analyzing any one out of: The second data or the first data and the second data.

The first network node 131 may further be configured to, e.g. means of the determining unit 720, determine third communication data based on analyzing any one out of: The third data, the first data and the third data, the second data and the third data, or the first data, the second data and the third data.

The first network node 131 is further configured to, e.g. means of a sending unit 730, send a first request to a second network node 132 operating in the VPLMN. The first request is adapted to comprise the determined first communication data. The first request is further adapted to request a first action to be performed by the second network node 132. The first action is adapted to be related to the communication based on the determined first communication data.

The request sent the to the second network node 132 may adapted to be a charging request. The requested action may further be adapted to be related to time based charging. The second network node 132 may be a CDF.

The first network node 131 may further be configured to, e.g. means of the sending unit 730, send a second request to the second network node 132. The second request may be adapted to comprise the determined second communication data. The second may be further adapted to request a second action to be performed by the second network node 132. The second action may be adapted to be related to the communication based on the determined second communication data.

The first network node 131 may further be configured to, e.g. means of the sending unit 730, send a third request to the second network node 132. The third request may be adapted to comprise the determined third communication data. The third request may further be adapted to request a third action to be performed by the second network node 132. The third action may be adapted to be related to the communication based on the determined third communication data.

The requested action may be represented by a session related action adapted to comprise any one out of: An ACR Start action, an ACR Interim action, or an ACR Stop action.

The requested action may be represented by a session related action, and wherein the time related to the communication is adapted to comprise any one or more out of: A start time of the communication, an end time of the communication, a time duration of the communication, and a time of the request.

The requested action may be represented by a session unrelated action adapted to comprise an ACR Event action.

The requested action may be represented by a session unrelated action, and wherein the time related to the communication is adapted to comprise a time of the sent request.

The embodiments herein may be implemented through a respective processor or one or more processors, such as the processor 740 of a processing circuitry in the first network node 131 depicted in FIG. 5a, together with respective computer program code for performing the functions and actions of the embodiments herein. The program code mentioned above may also be provided as a computer program product, for instance in the form of a data carrier carrying computer program code for performing the embodiments herein when being loaded into the first network node 131. One such carrier may be in the form of a CD ROM disc. It is however feasible with other data carriers such as a memory stick. The computer program code may furthermore be provided as pure program code on a server and downloaded to the first network node 131.

The first network node 131 may further comprise a memory 750 comprising one or more memory units. The memory 750 comprises instructions executable by the processor 740 in the first network node 131. The memory 750 is arranged to be used to store e.g. information, messages, actions, requests, data, communication data and applications to perform the methods herein when being executed in the first network node 131.

In some embodiments, a computer program 760 comprises instructions, which when executed by the respective at least one processor 740, cause the at least one processor 740 of the first network node 131 to perform the actions above.

In some embodiments, a respective carrier 770 comprises the respective computer program 760, wherein the carrier 770 is one of an electronic signal, an optical signal, an electromagnetic signal, a magnetic signal, an electric signal, a radio signal, a microwave signal, or a computer-readable storage medium.

Those skilled in the art will appreciate that the units in the first network node 131 described above may refer to a combination of analog and digital circuits, and/or one or more processors configured with software and/or firmware, e.g. stored in the first network node 131, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

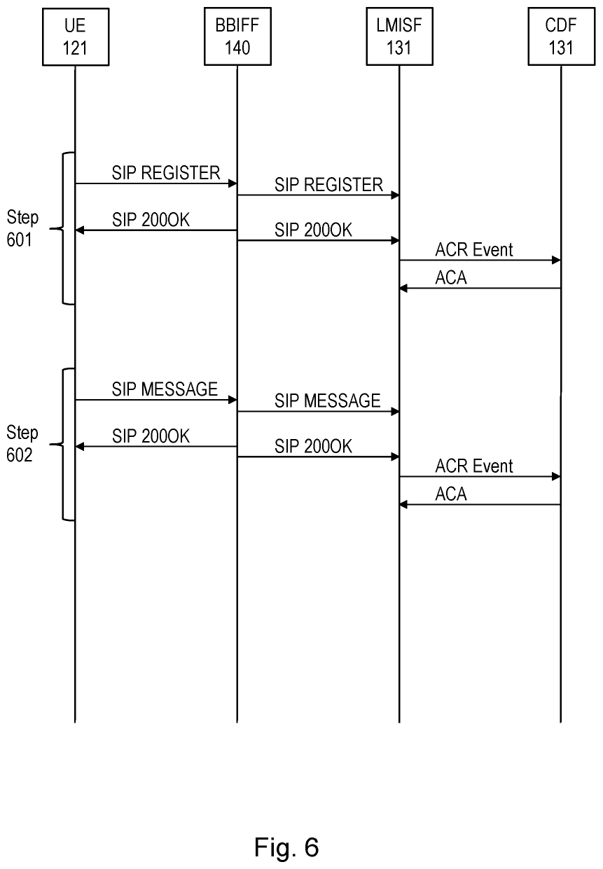

With reference to FIG. 8, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) such as the first UE 121 and/or a Non-AP STA 3291 located in coverage area 3213c is configured to wirelessly connect to, or be paged by, the corresponding base station 3212c. A second UE 3292 such as the second UE 122 and/or a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 8 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

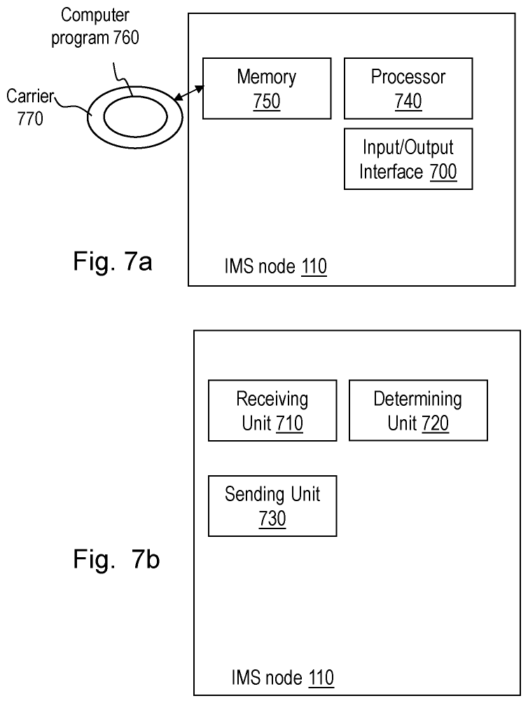

Example implementations, in accordance with an embodiment, of the UE, base station and host computer discussed in the preceding paragraphs will now be described with reference to FIG. 9. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 9) served by the base station 3320. The communication interface 3326 may be configured to facilitate a connection 3360 to the host computer 3310. The connection 3360 may be direct or it may pass through a core network (not shown in FIG. 9) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 9 may be identical to the host computer 3230, one of the base stations 3212a, 3212b, 3212c and one of the UEs 3291, 3292 of FIG. 8, respectively. This is to say, the inner workings of these entities may be as shown in FIG. 9 and independently, the surrounding network topology may be that of FIG. 8.

In FIG. 9, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the [select the applicable RAN effect: data rate, latency, power consumption] and thereby provide benefits such as [select the applicable corresponding effect on the OTT service: reduced user waiting time, relaxed restriction on file size, better responsiveness, extended battery lifetime].

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

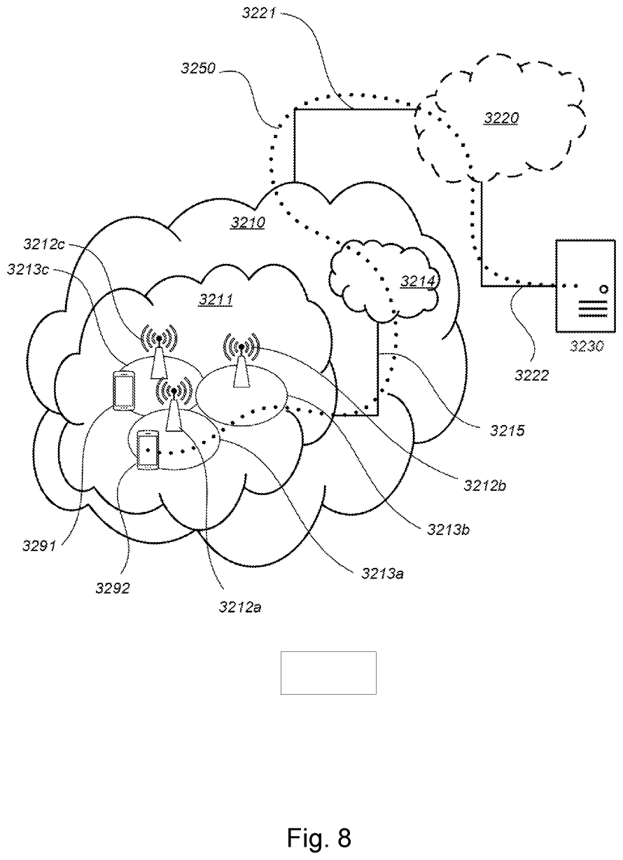

FIG. 10 is a flowchart illustrating a method implemented in a communication system, in accordance with one embodiment. The communication system includes a host computer, a base station such as a AP STA, and a UE such as a Non-AP STA which may be those described with reference to FIG. 8 and FIG. 9. For simplicity of the present disclosure, only drawing references to FIG. 10 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

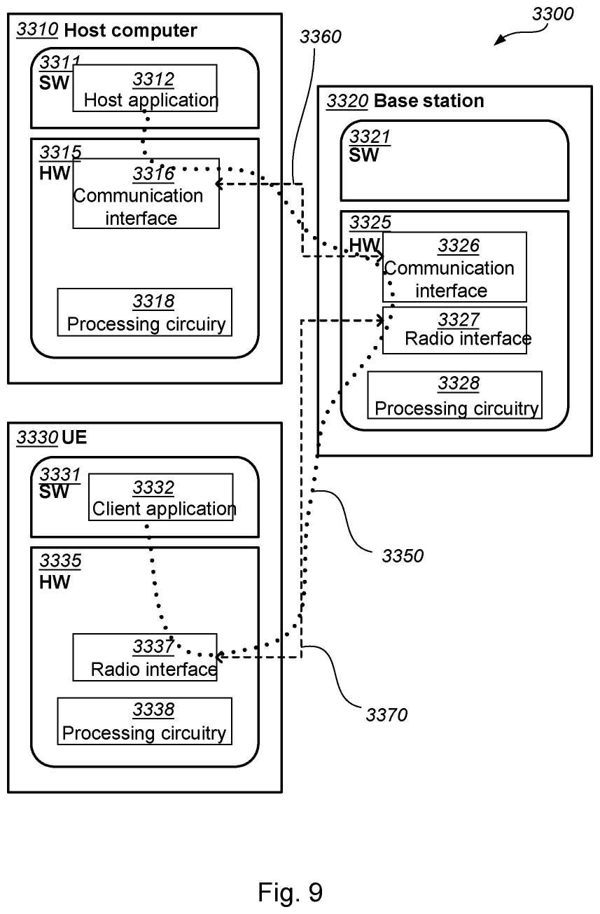

FIG. 11 is a flowchart illustrating a method implemented in a communication system, in accordance with one embodiment. The communication system includes a host computer, a base station such as a AP STA, and a UE such as a Non-AP STA which may be those described with reference to FIG. 8 and FIG. 9. For simplicity of the present disclosure, only drawing references to FIG. 11 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

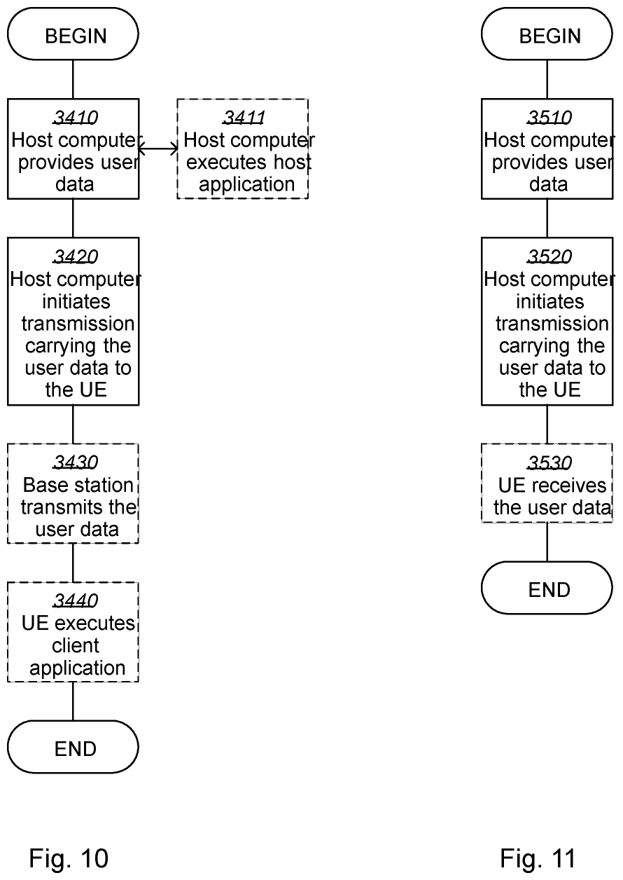

FIG. 12 is a flowchart illustrating a method implemented in a communication system, in accordance with one embodiment. The communication system includes a host computer, a base station such as a AP STA, and a UE such as a Non-AP STA which may be those described with reference to FIG. 8 and FIG. 9. For simplicity of the present disclosure, only drawing references to FIG. 12 will be included in this section. In an optional first step 3610 of the method, the UE receives input data provided by the host computer. Additionally, or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

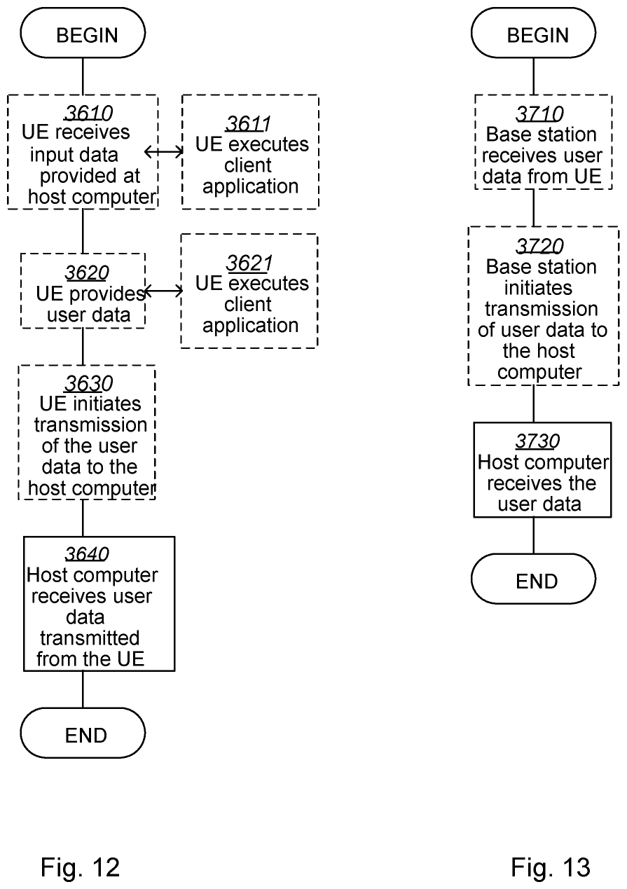

FIG. 13 is a flowchart illustrating a method implemented in a communication system, in accordance with one embodiment. The communication system includes a host computer, a base station such as an AP STA, and a UE such as a Non-AP STA which may be those described with reference to FIG. 8 and FIG. 9. For simplicity of the present disclosure, only drawing references to FIG. 13 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

1. A method performed by a first network node in an Visited Public Land Mobile Network, VPLMN, for determining data related to a communication between a first User Equipment, UE, and a second UE in a communications network, the first network node being related to Lawful Intercept, LI, in the VPLMN, which first UE is associated with an Home Public Land Mobile Network, HPLMN, and which first UE is located in the VPLMN, the method comprising:
when the communication is started, receiving a first Session Initiation Protocol, SIP, message from a gateway node in the VPLMN, the gateway node being related to LI in the VPLMN, and the first SIP message comprising first data related to starting of the communication;
determining, based on analysing the first data, first communication data comprising:
identities of the first UE and the second UE;
a time related to the communication;
type of content in the communication; and
roaming user location information related to the first UE of the communication; and
sending a first request to a second network node operating in the VPLMN, which first request comprises the determined first communication data and requests a first action to be performed by the second network node, which first action is related to the communication based on the determined first communication data.

2. The method according to claim 1, wherein:
receiving the first SIP message further comprises triggering the first network node to act as a Charging Trigger Function, CTF; and
wherein the request sent the to the second network node is a charging request and the requested action is further related to time based charging, and which second network node is a Charging Data Function, CDF.

3. The method according to claim 1, further comprising:
during the communication, receiving one or more second SIP messages from the gateway node, which one or more second SIP messages comprises second data related to updating the communication;
determining second communication data based on analysing any one out of:
the second data; and
the first data and the second data; and
sending a second request to the second network node, which second request comprises the determined second communication data and requests a second action to be performed by the second network node, which second action is related to the communication based on the determined second communication data.

4. The method according to claim 1, further comprising:
at the end of the communication, receiving one or more third SIP messages from the gateway node, which one or more third SIP messages comprises third data related to ending the communication;
determining third communication data based on analysing any one out of:
the third data;
the first data and the third data;
the second data and the third data; and
the first data, the second data and the third data; and
sending a third request to the second network node, which third request comprises the determined third communication data and requests a third action to be performed by the second network node, which third action is related to the communication based on the determined third communication data.

5. The method according to claim 1, wherein the requested action is represented by a session related action comprising any one out of:
an Accounting Request, ACR, Start, action;
an ACR Interim action; and
an ACR Stop action.

6. The method according to claim 1, wherein the requested action is a session related action, and wherein the time related to the communication comprises any one or more out of:
a start time of the communication;
an end time of the communication;
a time duration of the communication; and
a time of the request.

7. The method according to claim 1, wherein the requested action is represented by a session unrelated action comprising an ACR Event action.

8. The method according to claim 1, wherein the requested action is a session unrelated action, and wherein the time related to the communication comprises a time of the sent request.

9. The method according to claim 1, wherein the communication is routed via the S8 interface according to the S8 Home Routing, S8HR, architecture.

10. The method according to claim 1, wherein any one or more out of: the first network node is a Lawful intercept Mirror Internet protocol multimedia system State Function, LMISF, node, and the gateway node is a Bearer Binding Intercept and Forwarding Function, BBIFF, node.

11. A non-transitory computer storage medium storing a computer program comprising instructions, which when executed by a processor in an Visited Public Land Mobile Network, VPLMN, causes the processor to perform a method for determining data related to a communication between a first User Equipment, UE, and a second UE in a communications network, the first network node being related to Lawful Intercept, LI, in the VPLMN, which first UE is associated with an Home Public Land Mobile Network, HPLMN, and which first UE is located in the VPLMN, the method comprising:
when the communication is started, receiving a first Session Initiation Protocol, SIP, message from a gateway node in the VPLMN, the gateway node being related to LI in the VPLMN, and the first SIP message comprising first data related to starting of the communication;
determining, based on analysing the first data, first communication data comprising:
identities of the first UE and the second UE;
a time related to the communication;
type of content in the communication; and
roaming user location information related to the first UE of the communication; and
sending a first request to a second network node operating in the VPLMN, which first request comprises the determined first communication data and requests a first action to be performed by the second network node, which first action is related to the communication based on the determined first communication data.

12. (canceled)

13. A first network node in an Visited Public Land Mobile Network, VPLMN, configured to determine data related to a communication between a first User Equipment, UE, and a second UE in a communications network, the first network node being related to Lawful Intercept, LI, in the VPLMN, which first UE is associated with an Home Public Land Mobile Network, HPLMN, and which first UE is located in the VPLMN, the first network node being further configured to:
when the communication is started, receive a first Session Initiation Protocol, SIP, message from a gateway node in the VPLMN, the gateway node being related to LI in the VPLMN, and the first SIP message being configured to include first data related to starting the communication;
determine, based on analysing the first data, first communication data comprising:
identities of the first UE and the second UE;
a time related to the communication;
type of content in the communication; and
roaming user location information related to the first UE of the communication; and
send a first request to a second network node operating in the VPLMN, which first request comprises the determined first communication data and further requests a first action to be performed by the second network node, which first action is related to the communication based on the determined first communication data.

14. The first network node according to claim 13, wherein:
the first SIP message is adapted to trigger the first network node to act as a Charging Trigger Function, CTF; and
wherein the request sent the to the second network node is a charging request and the requested action is further related to time based charging, and which second network node is a Charging Data Function, CDF.

15. The first network node according to claim 13, further configured to:
during the communication, receive one or more second SIP messages from the gateway node, which one or more second SIP messages are adapted to comprise second data related to updating the communication; and
determine second communication data based on analysing any one out of:
the second data,
the first data and the second data; and
send a second request to the second network node, which second request comprises the determined second communication data and further requests a second action to be performed by the second network node, which second action is related to the communication based on the determined second communication data.

16. The first network node according to claim 13, further configured to:
at the end of the communication, receive one or more third SIP messages from the gateway node, which one or more third SIP messages comprises third data related to ending the communication; and
determine third communication data based on analysing any one out of:
the third data;
the first data and the third data;
the second data and the third data; and
the first data, the second data and the third data; and
send a third request to the second network node, which third request comprises the determined third communication data and further requests a third action to be performed by the second network node, which third action is related to the communication based on the determined third communication data.

17. The first network node according to claim 13, wherein the requested action is represented by a session related action comprising any one out of:
an Accounting Request, ACR, Start, action;
an ACR Interim action; and
an ACR Stop action.

18. The first network node according to claim 13, wherein the requested action is a session related action, and wherein the time related to the communication comprises any one or more out of:
a start time of the communication;
an end time of the communication;
a time duration of the communication; and
a time of the request.

19. The first network node according to claim 13, wherein the requested action is represented by a session unrelated action comprising an ACR Event action.

20. The first network node according to claim 13, wherein the requested action is a session unrelated action, and wherein the time related to the communication comprises a time of the sent request.

21. The first network node according to claim 13, wherein the communication is configured to be routed via the S8 interface according to the S8 Home Routing, S8HR, architecture.

22. The first network node according to claim 13, wherein any one or more out of: the first network node is a Lawful intercept Mirror Internet protocol multimedia system State Function, LMISF, node, and the gateway node is a Bearer Binding Intercept and Forwarding Function, BBIFF, node.
